(19) United States
(12) Patent Application Publication
(10) Pub. No.: US 2010/0162841 A1
(43) Pub. Date: Jul. 1, 2010

(54) GEARBOX FOR BICYCLES AND GEAR CHANGE SYSTEM

(76) Inventor: Guy Cavalerie, Pelussin (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/530,768

(22) PCT Filed: Mar. 10, 2008
(86) PCT No.: PCT/FR2008/000309

§ 371 Date: Jan. 23, 2010

(30) Foreign Application Priority Data
Mar. 16, 2007 (FR) 0701897

(51) Int. Cl. B62M 11/06; F16H 3/08; F16H 59/02

(52) U.S. Cl. 74/335; 74/374

(57) ABSTRACT

The invention relates to a set of devices for changing the gear ratio in a gearbox without false neutral positions. A casing includes: on a first axis, the shaft of the crankset including a primary sprocket, a tertiary shaft including fixed tertiary sprockets and tertiary sprockets on a free wheel; on a second axis, a secondary shaft includes a primary sprocket and secondary sprockets with inner flutes capable of free rotation on a smooth cylindrical bearing of the secondary shaft. The claims also relate to the following devices: each secondary sprocket has associated thereto one or more ratchets urged by a spring into a flute of the smooth bearing. A shuttle controlled by the user and moving inside the shaft applies a pressure, via spring loaded tabs, on the ratchets of the associated sprocket, which permits the engagement of two neighbouring sprockets during a gear change without any blocking or false neutral position. The largest tertiary sprockets are mounted on a free wheel in order to limit the overdrive of the small secondary sprockets when using the longest gear ratios.

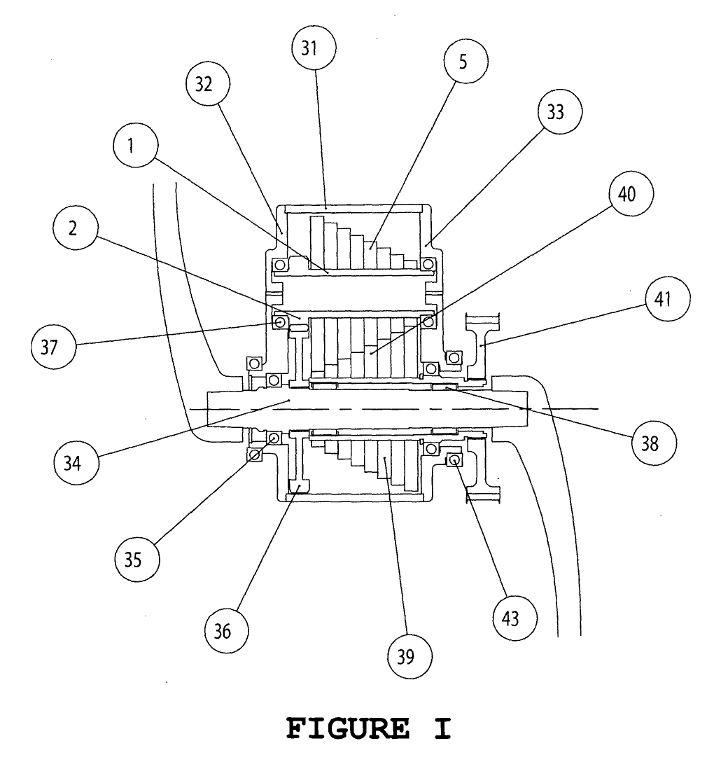

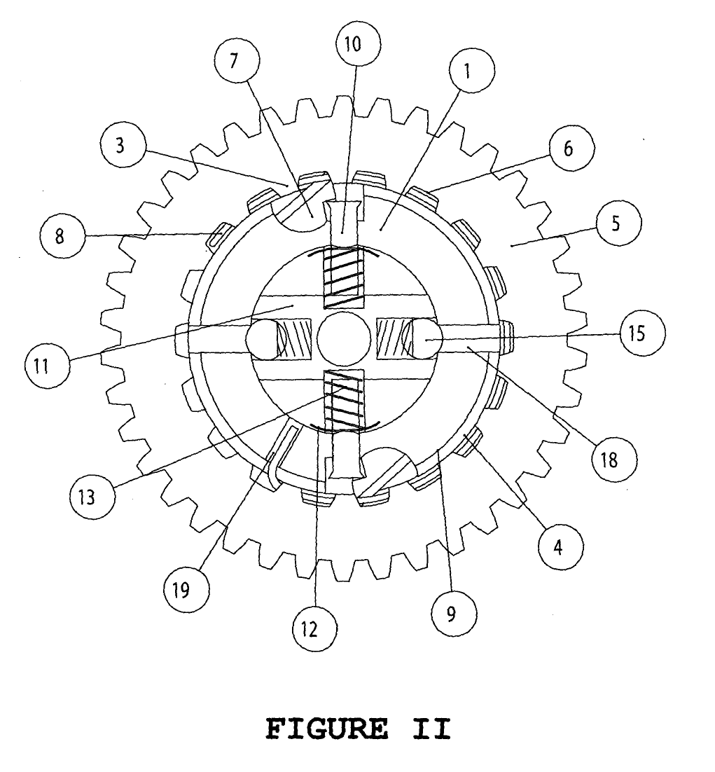

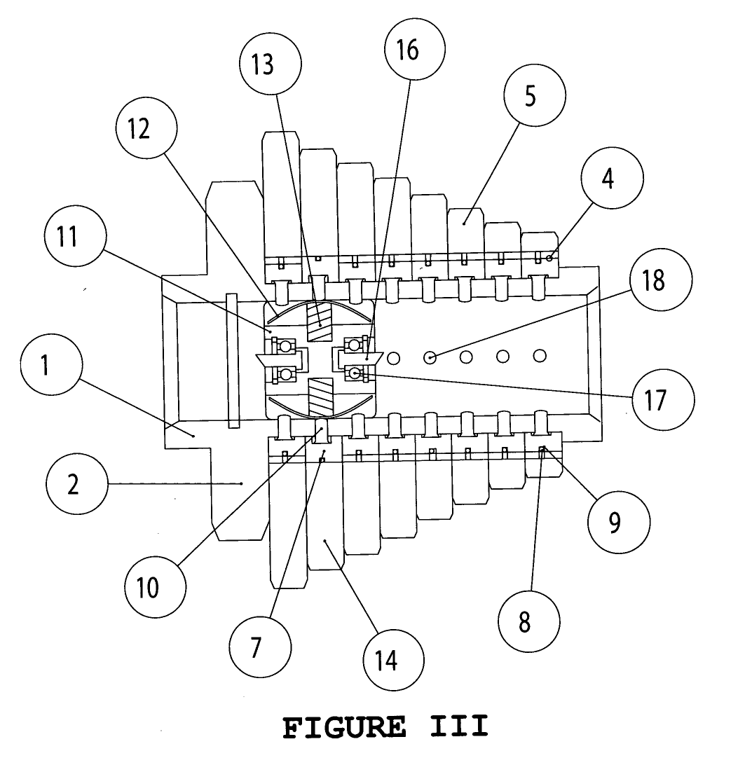

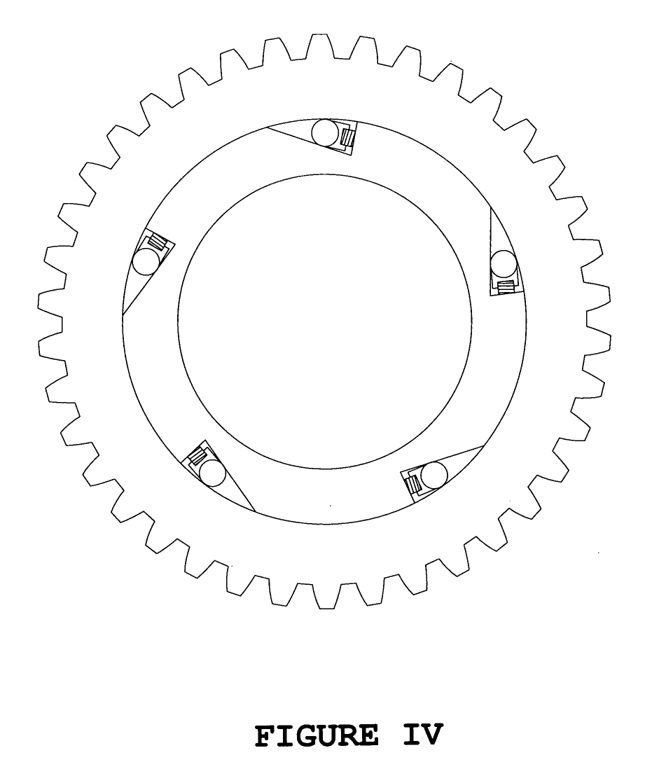

This invention applies to the technical field of gear transmissions designed for cycles.

Among the numerous transmissions systems for gear cycles existing or only patented, certain ones reemploy the general concept of cross piece transmission.

This type of transmission is useful for an application to cycles, due to their reduced bulkiness, but has the drawback of a “neutral position” phase during gear shiftings which, in addition to the risk of an injury to the cyclist, leads quite rapidly to the destruction of the cross piece or of the gear splines. Thus this system could not be developed.

The automobile-type claw transmission system has the drawbacks of a significant bulkiness, a high weight, and the same problem of “neutral position” phases during gear shiftings, incompatible for an application to the bicycle.

The present invention describes the mechanism that enables gear shifting in a bicycle transmission, eliminating this problem in particular.

The general principle of the transmission is of the type known as cross piece, but the systems of locking and selection of gears are different.

The innovation comprises disassociating the “control” part from the parts subjected to the torque transmitted to the wheel. The cyclist need not laterally displace the cross piece ensuring locking as in known systems.

### GENERAL PRINCIPLE

FIG. I shows the principal elements of the transmission of the type known as “cross piece”.

The transmission is positioned inside a single housing composed of a central part (31) and two lateral flanges (32, 33) supporting the shaft bearings.

On the first axis, in the interior of the housing, there are: the pedal assembly shaft made of treated steel (34) on bearings (35), a primary overdrive gear made of treated steel (36), the tertiary shaft made of treated steel (40) on needle bearings (38) and the tertiary gears made of treated steel (39), the largest ones of which being mounted on a freewheel system, thus avoiding the overdriving effect (FIG. IV) of associated secondary gears. This system is the subject of a claim.

On the second axis, in the interior of the housing, there is the secondary shaft made of treated steel (1) on bearings (37), a primary overdrive gear made of treated steel (2), the secondary gears made of treated steel (5) and the claimed gear shifting system.

Exterior of the housing, there is: a notched pulley, for a belt, made of aluminium alloy (41) or a gear, for a chain, made of treated steel, to drive the rear wheel and possibly two pivot bearings (43) of the rear wheel suspension arm.

### DESCRIPTION OF OPERATION

FIGS. II, III, and IV show the operation and the constitutive parts.

FIG. II shows a sectional view from an end of the secondary shaft. In this view, the gear (5) is locked.

FIG. III shows an 8 gear version with a primary gear composed of a gear joined to the pedal assembly and a gear (2) joined to the secondary shaft (1).

The pedal assembly drives the secondary shaft (1) via the primary gear (2).

On a smooth cylindrical bearing surface of the secondary shaft (4), the secondary gears (5) turn freely; the latter comprise internal splines (6) or any other shape that enables the engagement of pawls (7), and a circular groove (9) enabling the expansion of an elastic system (8) for return of the pawls.

The pawls are positioned in machined grooves by sweeping on the smooth cylindrical bearing surfaces. With each gear are associated one or several pawls pressed in the grooves by a spring back system, here an open toric ring (8), which is itself housed in a circular groove of the secondary shaft (9).

A device, here a piston (10), a ball or a catch being part of the pawl, positioned in a bore in the secondary shaft, projecting into the interior of the secondary shaft and, positioned under each pawl, can raise it.

In the interior of the secondary shaft moves a shuttle (11) comprising steel tabs (12) on springs (13) housed in grooves. These tabs come to apply a pressure under the pistons and engage the pawls in the splines of the selected gear.

The secondary shaft (1) thus drives the selected gear (14), which transmits the movement to the associated tertiary gear and enables rotation of the tertiary shaft.

The notched pulley (41) or the chain gear mounted on the tertiary shaft at the exterior of the housing transmits the movement to the wheel via a notched belt or a chain.

The displacement of the shuttle is controlled by one or two cables (16) on bearings (17) coupled to a rotating handle positioned on the cycle handlebar.

The shuttle also comprises one or several indexing balls on springs (15) that come to partially engage in bores (18) of the secondary shaft, or any other device for precisely positioning the shuttle under the selected gear generating indexing points between the shuttle and the secondary shaft.

This also enables the cyclist to select the desired gear, with the aid of the slight resistance felt when operating the rotating handle.

When shifting gears, the tabs on springs (12) raise the selected pistons (10) before releasing the relinquished pistons.

At this moment, the tabs raise two neighboring pistons, the biggest gear is driven, the smallest is in free wheel, the latter turning faster than the shaft; the rods between splines (3) come to push back the pawls in the grooves.

This enables avoidance of the false neutral positions and the engagement problems of teeth or claws of existing transmissions.

In order to reduce the overdriving effect of small secondary gears (5) when the highest gears are selected, the biggest tertiary gears (39) are mounted free wheel on the tertiary shaft. (FIG. IV).

### Advantages of the Presented Device

Constant alignment of the belt or transmission chain.
Enables the use of a belt.
No derailleur necessary, no frequent tuning needed.
Greatly reduced maintenance.
Housing protected from water and mud sprays, shocks and branches
Weight advantage over the other existing transmissions.
Reduction of non suspended weight (the wheel hub comprises only a single gear or notched pulley).
Increased ground clearance (less than 50 mm below the axel of the pedal assembly).
Smooth and precise control, no detuning due to cables.
Possibility of “stepping up” the ratios without releasing force.
Possibility of passing through gears even when stopped.
Possibility of passing through several gears simultaneously.
It is no longer necessary to release force on the pedals to “step down” the ratio.

Avoided drawbacks of claw transmissions
high weight and bulkiness.
false neutral positions between gears.
engagement problems of teeth and claws.

Avoided drawbacks of the cross piece transmissions.
displacement problems and fragility of the cross piece.
lateral engagement problems of the cross piece in the splines.

1. Device enabling gear shifting in a gearbox designed for cycles comprising, on a primary axis, a pedal assembly shaft, mounted on bearings with a primary overdrive gear, a tertiary shaft with needle bearings, tertiary gears, and, on a secondary axis, a secondary shaft on bearings characterized in that the aforementioned secondary shaft comprises:
a primary overdrive gear
a smooth bearing surface on which are positioned secondary gears
one or several machined grooves on the smooth bearing surface, designed to house pawls
a series of circular grooves designed to house an elastic return system for pawls,
a series of bores designed to house pistons, balls, or any other system enabling raising of the pawls
another series of bores designed for partial engagement of indexing balls.

2. Device according to claim 1 for gear shifting, characterized in that it comprises secondary gears able to turn freely on a smooth bearing surface, comprising interior splines or any other shape enabling engagement of the pawls and a circular groove enabling the expansion of a return system.

3. Device according to claim 1, characterized in that pawls are pressed in secondary shaft grooves by a return system and are associated with each secondary gear.

4. Device according to claim 1 characterized in that pistons, balls or catch for pawls are positioned in the drillings in the interior of the secondary shaft and project into the interior of the secondary shaft so as to be able to raise the pawls.

5. Device according to claim 1, characterized in that a shuttle moving in the interior of the secondary shaft, comprises one or two bearings for the wire control, grooves in which are positioned tabs on springs enabling the raising of the pistons, one or several indexing ball on springs.

6. Device according to claim 1 characterized in that the biggest tertiary gears are mounted on a free wheel system on the tertiary shaft so as to reduce the overdriving effect of the small secondary gears.
